(19) United States
(12) Patent Application Publication
(10) Pub. No.: US 2013/0175400 A1
(43) Pub. Date: Jul. 11, 2013

(54) Extending the Schwarzschild Derivation to a Pseudo-Spherical Space-time

(71) Applicant: Adam G. Freeman, Glendale, CA (US)

(72) Inventor: Adam G. Freeman, Glendale, CA (US)

(21) Appl. No.: 13/694,843

(22) Filed: Apr. 17, 2011

(51) Int. Cl. B64G 1/00

(52) U.S. Cl. CPC B64G 1/00
USPC 244/158.1

(57) ABSTRACT

This invention explains what anti-matter and black holes really are and how they can be used in a space ship to achieve space travel.

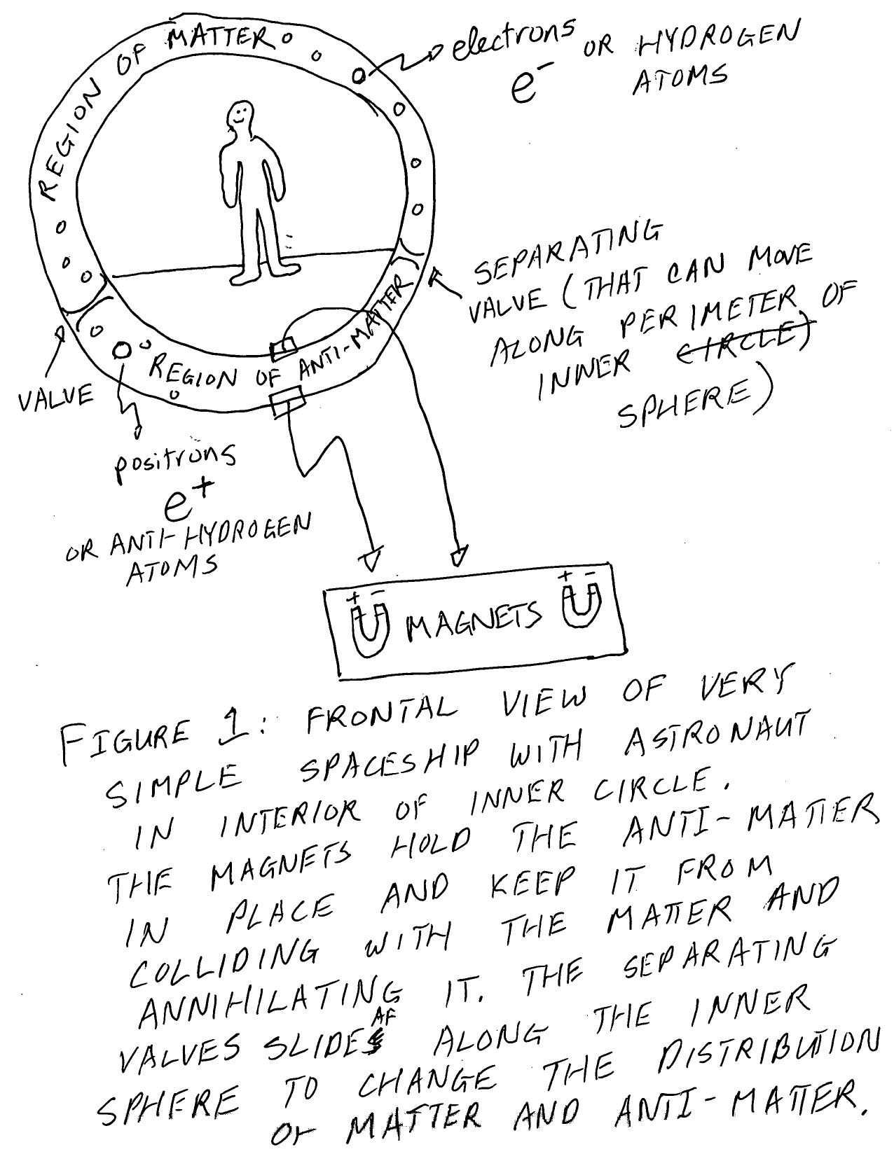

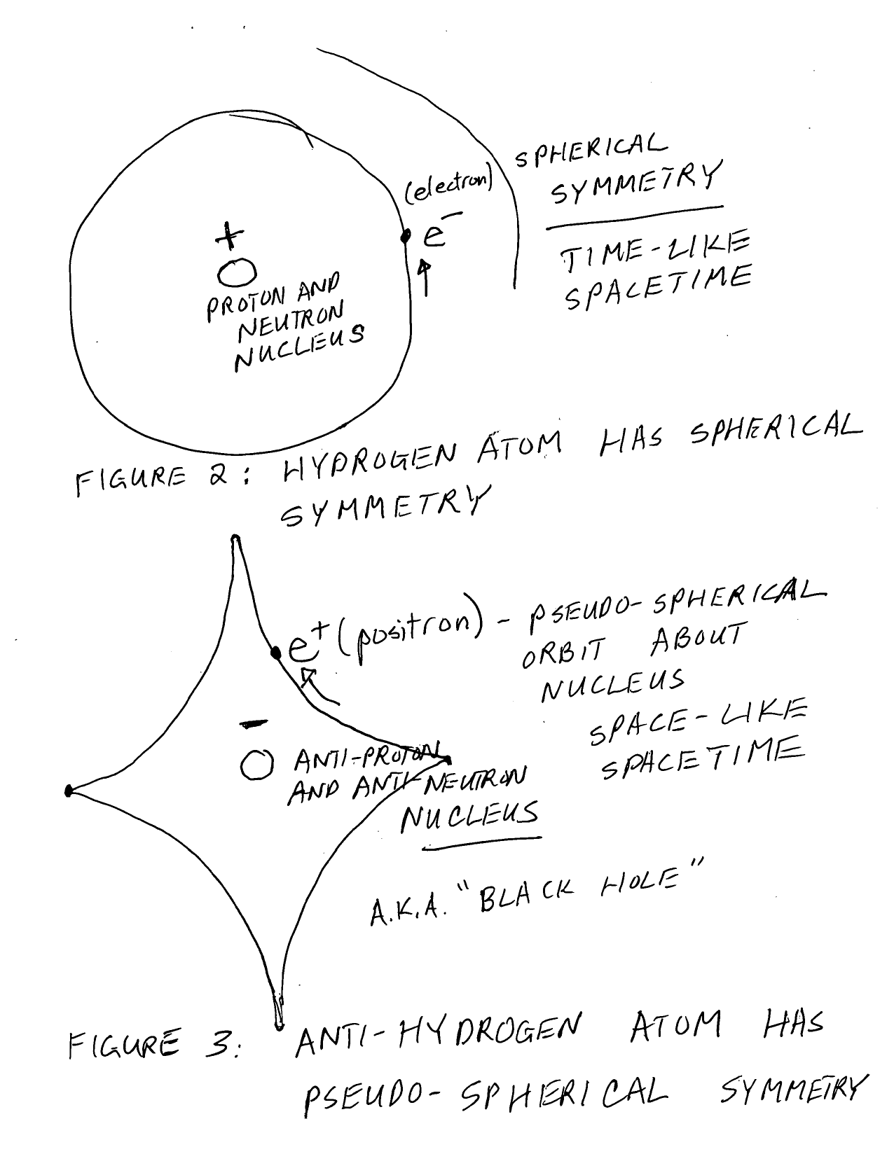

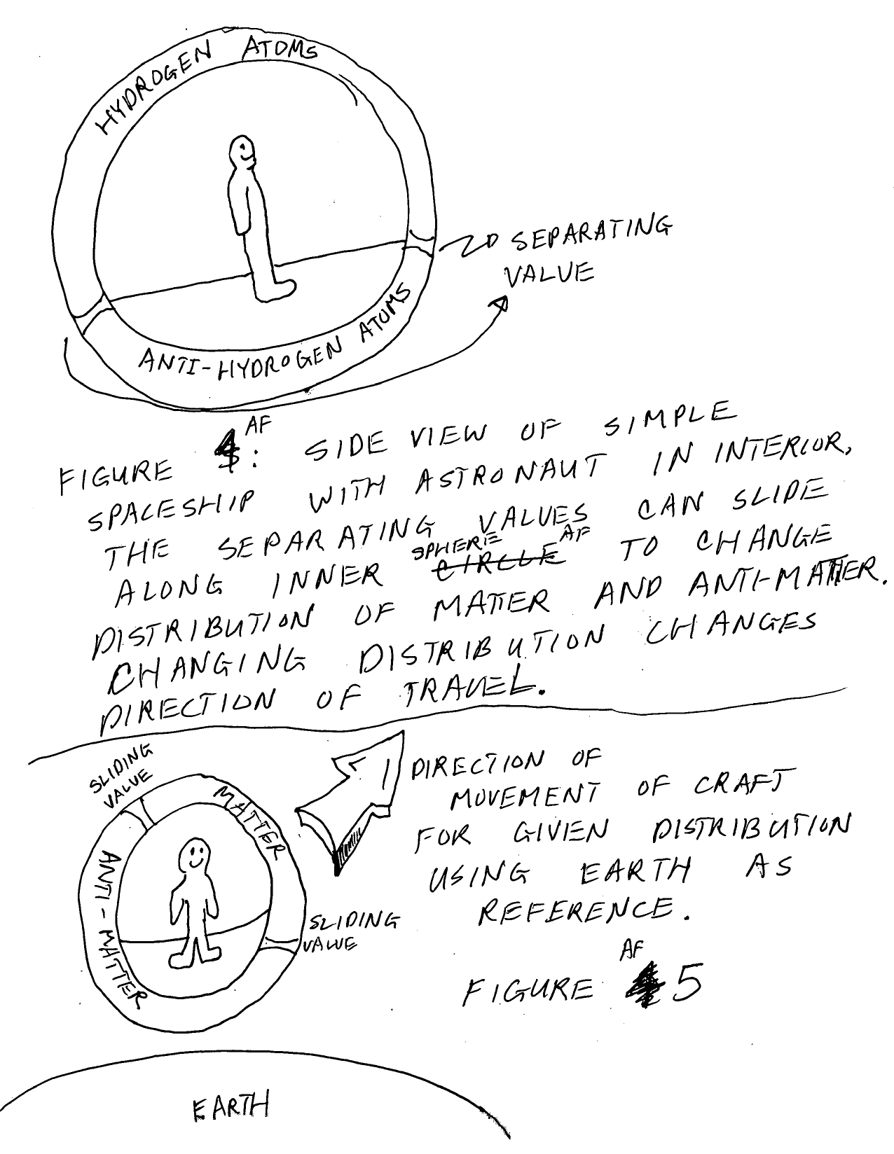

Here is presented an extension to the Schwarzschild derivation for the vacuum field equations corresponding to the gravitational field surrounding a pseudo-spherical point mass. The same restrictions employed by Schwarzschild are used here but an interesting property of the space-time is elicited in that it is valid for a radius greater than zero but less than 2 GM/c² and so is bounded by 0<r<2 GM/c². Also the mass appears to be gravitationally repulsive as opposed to gravitationally attractive. The pseudo-sphere point mass solution complements the spherical Schwarzschild solution which is valid for a radius greater than 2 GM/c².

Keywords: Schwarzschild radius, general relativity, vacuum field equations, pseudo-sphere

### Introduction

In 1916, K. Schwarzschild introduced the first full solution to Einstein's vacuum field equations [1]. Since that time, there have been numerous other solutions such as the Kerr solution [6], the Anti-de-Sitter solution, the work in cosmology by Lemaítre, Friedman, Robertson and Walker, Gödel [4] and numerous others. In fact since any geometry can lead to a vacuum field solution, there exist an infinite number of such solutions. But since the Schwarzschild solution represents something observed in nature (the planets in the solar system orbiting the sun) it remains fundamental and is easier to grasp and understand than some of the more mathematically rigorous solutions.

Something else that is observed in nature is the tractrix (or “hound curve”) which was first introduced by Claude Perrault in 1670 and further studied by Leibniz, Newton and others. By revolving the tractrix around an axis, one obtains the familiar pseudo-sphere which is a surface of constant negative curvature that can be used as a geometry for hyperbolic space-time. Embedding the pseudo-sphere in such a space-time is beyond the scope of this paper and such work has been performed in [3]. This paper focuses on re-deriving the Schwarzschild solution for a pseudo-spherical point mass.

### Assumptions

The same assumptions used in the Schwarzschild derivation are employed here:

1.) The space-time surrounding the point mass is static.

2.) The space-time surrounding the point mass is isotropic.

3.) At a sufficient distance away from the point mass, the space-time becomes flat Minkowski space-time.

4.) The metric at the surface must match the metric at the interior (boundary condition.)

### Derivation

The geodesic equation typically used for the Schwarzschild derivation resembles:

ds²=−e^{N(r)}c²dt²+e^{P(r)}dr²+r²dθ²+r²sin²(θ)dφ², (1)

where the constants N(r) and P(r) are determined using Einstein's vacuum field equations. Note that in the canonical Schwarzschild derivation for a spherical space-time metric with signature [−1, +1, +1, +1], this geodesic yields the familiar equation:

$${ds}^{2} = - ( 1 - \frac{2 GM}{{rc}^{2}} ) {c}^{2} {dt}^{2} + \frac{{dr}^{2}}{1 - ( 2 GM / {rc}^{2} )} + {r}^{2} d {θ}^{2} + {r}^{2} {sin}^{2} ( θ ) d {φ}^{2} , \qquad ( 2 )$$

The geodesic equation corresponding to a pseudo-sphere used in the derivation for this paper is similar to (1) and appears as:

ds²=−e^{N(r)}c²dt²+e^{P(r)}dr²+r²dθ²+r²sin h²(θ)dφ², (3)

The only difference between this geodesic and (1) is the fourth term.

The diagonal metric g_{a,b} used for the derivation in this paper has signature [−1, +1, +1, +1] and appears in tensor form as:

$${g}_{a , b} = ( \begin{matrix}- {e}^{N ( r )} & 0 & 0 & 0 \\ 0 & {e}^{P ( r )} & 0 & 0 \\ 0 & 0 & {r}^{2} & 0 \\ 0 & 0 & 0 & {r}^{2} {sinh}^{2} ( θ )\end{matrix} ) , \qquad ( 4 )$$

Using Maple 14 to solve for the Einstein tensor and simplifying, we find that the only Einstein tensor non-zero components are:

$$\begin{matrix}G 11 = \frac{{e}^{N ( r )} ( - ( {P}^{′} ( r ) ) r + {e}^{P ( r )} + 1 )}{{r}^{2} {e}^{P ( r )}} = 0 , & ( 5 ) \\ G 22 = - \frac{( {N}^{′} ( r ) ) r + {e}^{P ( r )} + 1}{{r}^{2}} = 0 , & ( 6 ) \\ G 33 = - \frac{1}{4} \frac{\begin{matrix}r ( 2 ( {N}^{′} ( r ) ) - 2 ( {P}^{′} ( r ) ) + {r ( {N}^{′} ( r ) )}^{2} - \\ r ( {N}^{′} ( r ) ) ( {P}^{′} ( r ) ) + 2 r ( {N}^{″} ( r ) ) )\end{matrix}}{{e}^{P ( r )}} = 0 , & ( 7 ) \\ G 44 = G 33 {sinh}^{2} ( θ ) = 0 , & ( 8 )\end{matrix}$$

Solving for N(r) and P(r) yields:

$$\begin{matrix}P ( r ) = - N ( r ) , & ( 9 ) \\ {e}^{P ( r )} = \frac{Cr}{1 - Cr} , & ( 10 )\end{matrix}$$

where C is some as yet undetermined constant.

Using the weak field approximation to determine the constant C, the constant is equivalent to 2 GM/c² as opposed to the constant from the original Schwarzschild derivation which is equivalent to −2 GM/c². This suggests that the pseudo-spherical mass is gravitationally repulsive as opposed to gravitationally attractive.

So we have our full solution for the pseudo-spherical geodesic equation:

$${ds}^{2} = ( 1 - \frac{2 GM}{{rc}^{2}} ) {c}^{2} {dt}^{2} - \frac{{dr}^{2}}{1 - ( 2 GM / {rc}^{2} )} + {r}^{2} d {θ}^{2} + {r}^{2} {sinh}^{2} ( θ ) d {φ}^{2} , \qquad ( 11 )$$

Comparing equation (11) with equation (2), you will notice that the first term and the second term of both equations are equivalent except for a sign change from equation (2) to equation (11) for both of the terms. Since r is valid in equation (2) when it is greater than 2 GM/c², r is valid in equation (11) when it is less than 2 GM/c² and greater than zero (since the point mass is located at position zero and a radius of zero would produce a singularity.) The author wishes to further emphasize that such a space-time is space-like as opposed to time-like.

### References

[1] Schwarzschild, K. On the gravitational field of a mass point according to Einstein's theory. Sitzungsber. Preuss. Akad. Wiss., Phys. Math. Kl., 189, 1916.
[2] Hilbert, D.Nachr.Ges.Wiss.Gottingen,Math.Phys.Kl.,v.53, 1917.
[3] Ozsváth, I., Sauter, A.: Gen Relativ Gravit (2008) 40:1981-1985.
[4] Gödel, K: Collected Works,vol.III,p.282.Oxford University Press, New York(1995).
[5] Misner C. W., Thorne K. S., Wheeler J. A. Gravitation. W. H. Freeman and Company, New York, 1973.
[6] Kerr, R. P. Gravitational field of a spinning mass as an example of algebraically special metrics, Physical Review Letters (1963), 11: 237-238.
[7] Cady, W. G.: The Circular Tractrix, The American Mathematical Monthly, Vol. 72, No. 10 (1965), pp. 1065-1071.

### Appendix

Simple Maple 14 script to reinforce and demonstrate pseudo-spherical derivation. Here G, c and M are all set to one for simplicity:

$$> restart \\ > with ( tensor ) ; \\ > coords := [ t , r , theta , phi ] ; \\ > g := array ( symmetric , sparse , 1 … 4 , 1 … 4 ) ; \\ > g [ 1 , 1 ] := 1 - 2 / r ; g [ 2 , 2 ] := - 1 / g [ 1 , 1 ] ;$$

$$g [ 3 , 3 ] := r \hat{} 2 ; g [ 4 , 4 ] := r \hat{} 2 * sinh ( theta ) \hat{} 2 ; \\ > metric := create ( [ - 1 , - 1 ] , eval ( g ) )$$

$$table ( [ compts = [ \begin{matrix}1 - \frac{2}{r} & 0 & 0 & 0 \\ 0 & - \frac{1}{1 - \frac{2}{r}} & 0 & 0 \\ 0 & 0 & {r}^{2} & 0 \\ 0 & 0 & 0 & {r}^{2} {sinh ( θ )}^{2}\end{matrix} ] , index\_char = [ - 1 - 1 ] ] ) \\ > tensorsGR ( coords , metric , contra\_metric , det\_met , C 1 , C 2 , Rm , Rc , R , G , C ) \text{:} \\ > displayGR ( Einstein , G )$$

$$The Einstein Tensor$$

$$non \text{-} zero components \text{:}$$

$$None$$

$$character \text{:} [ - 1 , - 1 ]$$

1. Anti-matter exists in a hyperbolic, pseudo-spherical spacelike spacetime.

2. In the case of anti-matter, gravity is repulsive. That is the gravitational potential force caused by anti-matter has a positive sign.

3. While matter makes distances in spacetime longer by curving the distance outwardly, anti-matter makes distances in spacetime shorter by curving the distance inwardly. (Just as for flat “Minkowski” spacetime the distance remains unchanged.)

4. A space ship that makes space travel actually feasible to parts of the Universe that are currently unfeasible can be constructed by utilizing anti-matter. Such details of the construction of such a ship are not considered here just that such a construction is possible.
